(19) United States
(12) Patent Application Publication
(10) Pub. No.: US 2008/0266461 A1
(43) Pub. Date: Oct. 30, 2008

(54) VIDEO PROCESSING CIRCUIT WITH MULTIPLE-INTERFACE

(75) Inventors: Chung-Hsun Huang, Fonghua Village (TW); Kuei-Hsiang Chen, Fonghua Village (TW)

Correspondence Address: LOWE HAUPTMAN HAM & BERNER, LLP, 1700 DIAGONAL ROAD, SUITE 300, ALEXANDRIA, VA, 22314, US

(73) Assignee: HIMAX TECHNOLOGIES LIMITED, Fonghua Village (TW)

(21) Appl. No.: 11/741,157

(22) Filed: Apr. 27, 2007

(51) Int. Cl. H04N 9/64

(52) U.S. Cl. 348/708; 348/E09.039

(57) ABSTRACT

A video processing circuit with multiple-interface has a multiple-interface device, a timing controller, and a register. The timing controller is capable of sequencing and transmitting a signal of a low voltage differential signal, a reduced swing differential signal type or a transistor-transistor logic signal type to the multiple-interface device. The register sets the multiple-interface device to be adapted to output the signals of the types to a source driver.

### BACKGROUND

1. Field of Invention

The present invention relates to a video processing circuit, and more particularly relates to a video processing circuit with a multiple-interface.

2. Description of Related Art

FIG. 1 is a video processing circuit of the prior art. The traditional video processing circuit has an interface 110, a timing controller (TCON) 120, a selector 125, and a register 140. The timing controller 120 may receive LVDS (low voltage differential signal), RSDS (reduced swing differential signal) type or TTL (transistor-transistor logic) signal from the scaler 150. The register 140 couples to the interface 110, the timing controller 120, the selector 125 and the scaler 150 to set the interface 110 to be adapted to output the signals for a source driver of a flat panel display 160.

There are many kinds of source drivers, some source drivers are for RSDS/TTL, and some are for LVDS/TTL. Therefore, the selector 125 is arranged to select the signal inputted to the interface 110 according to the type of the source driver 160.

In the traditional video processing circuit, in order to cooperate with different kinds of source drivers, the interface 110 needs two sets of the bounding pads for transmitting the signals of different types. However, this kind of design necessitates lots of bounding pads. Thus, a video processing circuit with multiple-interface to reduce the amount of the bounding pads is needed.

### SUMMARY

According to one embodiment of the present invention, the video processing circuit with multiple-interface has a multiple-interface device, a timing controller, and a register. The timing controller is capable of sequencing and transmitting a low voltage differential signal, reduced swing differential signal or a TTL signal to the multiple-interface device. The register sets the multiple-interface device to be adapted to output the signals of the types to a source driver.

It is to be understood that both the foregoing general description and the following detailed description are by examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is a video processing circuit of the prior art;

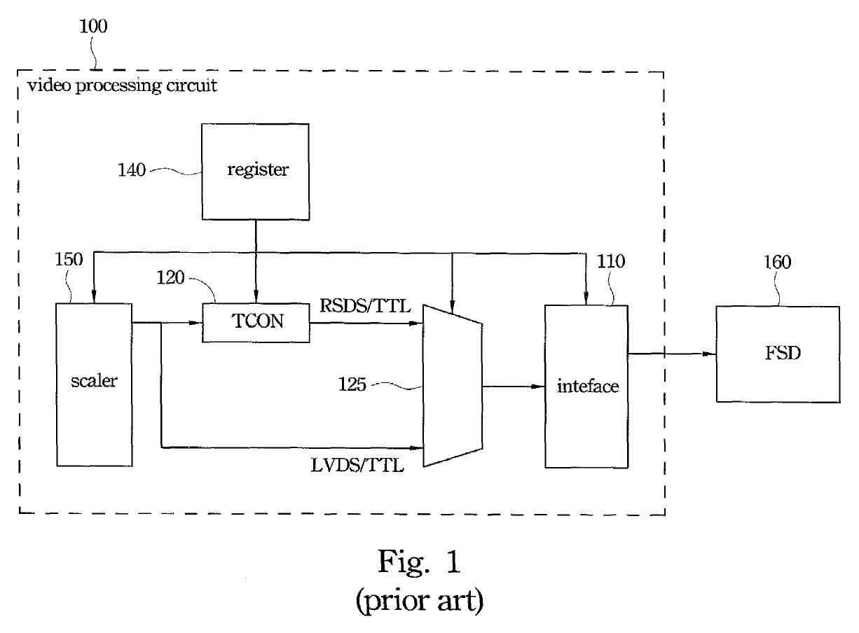

FIG. 2 is a video processing circuit with multiple-interface according to one embodiment of the present invention; and

FIG. 3 is the multiple-interface device of the embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

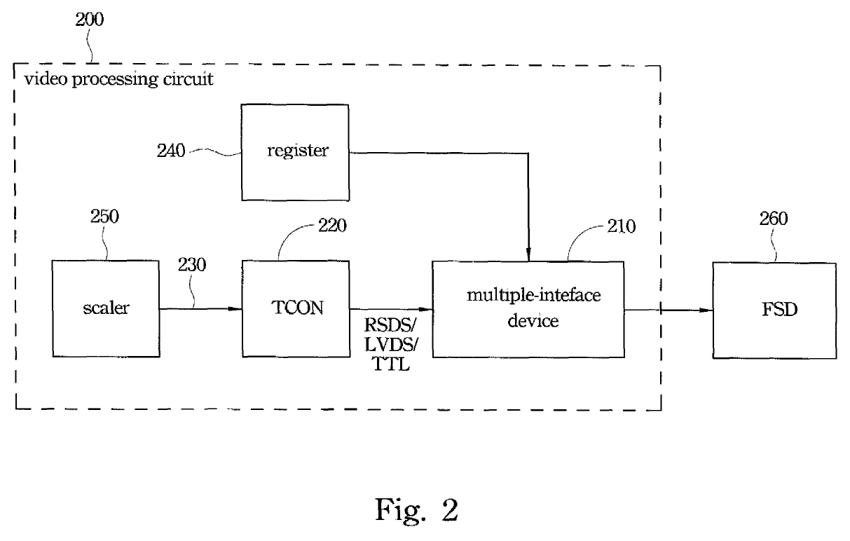

FIG. 2 is a video processing circuit with multiple-interface according to one embodiment of the present invention. The video processing circuit with multiple-interface has a multiple-interface device 210, a timing controller 220, and a register 240. The timing controller 220 is capable of sequencing and transmitting a signal (transmitted by line 230) of a LVDS type, a RSDS type or a TTL signal type to the multiple-interface device 210. The register 240 couples to and sets the multiple-interface device 210 to be adapted to output the signals of the types to a source driver of a flat panel display 260.

The video processing circuit with multiple-interface further has a scaler 250 to process and output the signal of the LVDS type, the RSDS type or the TTL signal type to the timing controller 220. The scaler 250 is arranged to optimize the resolution represented by the signal according to the flat panel display 260.

The signals here include several image signals (i.e. red, green, and blue image signals), a clock signal, and several control signals. Generally speaking, the image signals from the scaler 250 are LVDS, RSDS, or TTL signal, and the clock signal and control signals are TTL signals. However, the image signals processed by the source driver are sometimes LVDS or RSDS. Therefore, when the scaler 250 inputs TTL signals to the timing controller 220, and the source driver only deals with LVDS or RSDS, the video processing circuit needs some converters to convert the signals.

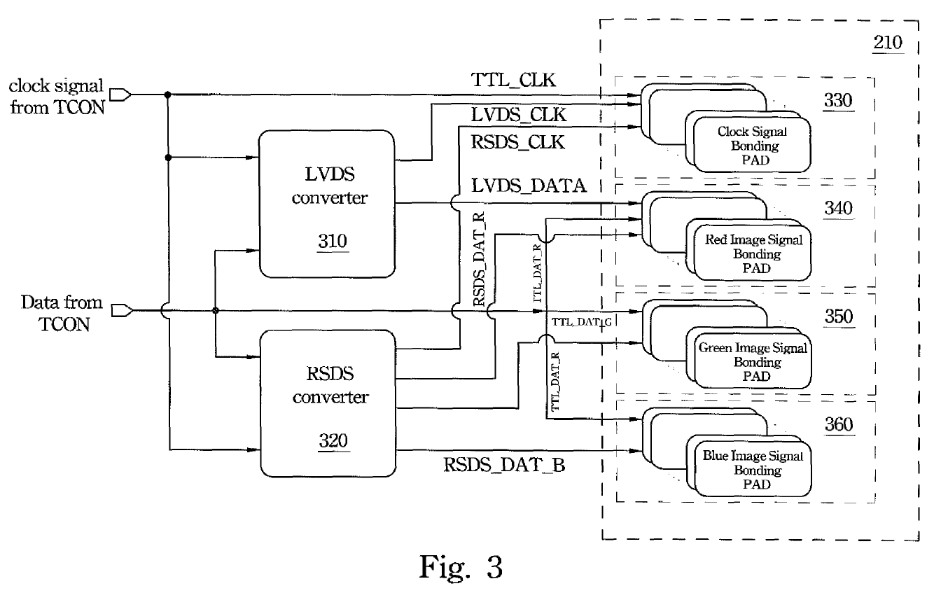

FIG. 3 is the multiple-interface device 210 of the embodiment of the present invention. The video processing circuit with multiple-interface further has an LVDS converter 310 to convert TTL signals into low voltage differential signals, and has an RSDS converter 320 to convert TTL signals into reduced swing differential signals. The LVDS converter 310 and RSDS converter 320 can be embedded in the timing controller (TCON) 220 of FIG. 2.

The multiple-interface device 210 has several bounding pads. These bounding pads can be divided into several groups according to the types (such as clock and image signal types) of the signals transmitted thereby. For example, the bounding pad groups 330, 340, 350, and 360 are arranged to respectively transmit at least one clock signal, at least one red image signal, at least one green image signal and at least one blue image signal. Moreover, in order to minimize the number of the bounding pads and make the design flexible, the control signals (not shown) can be separately transmitted by different bounding pad groups 330, 340, 350, and 360.

The designer can store the setting of the interface according to the requirement or specification. Usually, the designer can use the conventional setting protocol, such as the I2C protocol or the parallel interface protocol of MCU (microprocessor control unit), to set the interfaces. Therefore, the same bounding pad can be arranged to transmit different signals of LVDS, RSDS, or TTL signal.

The LVDS converter 310 couples to the timing controller 220, the clock signal bounding pads of group 330, the control signal bounding pads (separately located in the groups of 340, 350, or 360), and the image signal bounding pads of group 340, 350, or 360. The RSDS converter 320 couples to the timing controller 220, the clock signal bounding pads of group 330, the control signal bounding pads (separately located in the groups of 340, 350, or 360), and the image signal bounding pads of group 340, 350, or 360.

Usually, the video processing circuit deals with one clock signal, several image signals, and several control signals. Therefore, the video processing circuit needs one clock signal bounding pad for TTL type and one pair of clock signal bounding pads for LVDS/RSDS types. The video processing circuit also needs several control signal bounding pads and several image signal bounding pads. However, if the video processing circuit needs different clock signals, the amount of the clock signal bounding pads can be modified.

Moreover, before the signals are inputted into the bounding pads, the signals need to be mapped to get the correct sequence. Mapping processes such as the MSB/LSB (most significant bit/least significant bit) swap, data inverse, or red/blue swap may be used. Otherwise, the signals also need different mapping processes according to the interface types. For example, if the interface is a dual path RSDS interface, the signals need front-back swap; if the interface is a dual path LVDS/TTL interface, the signals need even-odd swap.

By the description above, the different signals can be transmitted to the corresponding bounding pads by the multiple-interface device 210 cooperating with the setting of the register 240. Therefore, the video processing circuit can supply the correct signal types to the source driver of the flat panel display 260.

The embodiments presented here enables the video processing circuit to offer different types of signals for different source drivers with the same hardware. The designer can change the setting of the register without changing the circuit layout to enable the video processing circuit to supply different signals for the source drivers. The invention thereby can reduce the design time and the manufacture cost.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A video processing circuit with multiple-interface, comprising:
a multiple-interface device;
a timing controller capable of sequencing and transmitting a signal of a low voltage differential signal type, a reduced swing differential signal type or a transistor-transistor logic signal type to the multiple-interface device; and
a register setting the multiple-interface device to be adapted to output the signals of the types to a source driver.

2. The video processing circuit with multiple-interface as claimed in claim 1, further comprising a scaler processing and outputting the signal of the low voltage differential signal type, the reduced swing differential signal type or the transistor-transistor logic signal type to the timing controller.

3. The video processing circuit with multiple-interface as claimed in claim 1, further comprising a low voltage differential signal converter to convert the type of an image signal from the transistor-transistor logic signal type into the low voltage differential signal type.

4. The video processing circuit with multiple-interface as claimed in claim 3, wherein the low voltage differential signal converter is arranged to convert the type of a clock signal from the transistor-transistor logic signal type into the low voltage differential signal type.

5. The video processing circuit with multiple-interface as claimed in claim 3, wherein the low voltage differential signal converter is arranged to convert the type of a control signal from the transistor-transistor logic signal type into the low voltage differential signal type.

6. The video processing circuit with multiple-interface as claimed in claim 1, further comprising a reduced swing differential signal converter to convert the type of the image signal from the transistor-transistor logic signal type into the reduced swing differential signal type.

7. The video processing circuit with multiple-interface as claimed in claim 6, wherein the reduced swing differential signal converter is arranged to convert the type of the clock signal from the transistor-transistor logic signal type into the reduced swing differential signal type.

8. The video processing circuit with multiple-interface as claimed in claim 6, wherein the reduced swing differential signal converter is arranged to convert the type of the control signal from the transistor-transistor logic signal type into the reduced swing differential signal type.

9. The video processing circuit with multiple-interface as claimed in claim 1, wherein the multiple-interface device comprises a plurality of bounding pads arranged to transmit at least one clock signal, at least one control signal, at least one red image signal, at least one green image signal and at least one blue image signal.

10. The video processing circuit with multiple-interface as claimed in claim 9, wherein parts of the clock signals, control signals, red image signals, green image signals and blue image signals share the bounding pads according to a setting of the register.

11. The video processing circuit with multiple-interface as claimed in claim 3, wherein the low voltage differential signal converter couples to the timing controller, a clock signal bounding pad, a control signal bounding pad, and a image signal bounding pad.

12. The video processing circuit with multiple-interface as claimed in claim 6, wherein the reduced swing differential signal converter couples to the timing controller, the clock signal bounding pad, the control signal bounding pad, and the image signal bounding pad.
